(19) United States
(12) Patent Application Publication
(10) Pub. No.: US 2026/0301569 A1
(43) Pub. Date: Oct. 1, 2026

(54) VEHICLE CONTROL SYSTEM, VEHICLE CONTROL METHOD, AND NON-TRANSITORY COMPUTER-READABLE STORAGE MEDIUM

(71) Applicant: HONDA MOTOR CO., LTD., Tokyo (JP)

(72) Inventors: Hiromu AOKI, Tokyo (JP); Nobuharu NAGAOKA, Tokyo (JP); Shun MORISHITA, Tokyo (JP)

(21) Appl. No.: 19/575,216

(22) Filed: Mar. 23, 2026

(30) Foreign Application Priority Data
Mar. 28, 2025 (JP) 2025-055004

(51) Int. Cl. G08G 1/0967; G08G 1/16

(52) U.S. Cl. CPC G08G 1/096766; G08G 1/166

(57) ABSTRACT

A vehicle control system comprises: a detector configured to detect a position of an object near a vehicle; a notifier configured to alert an occupant; and an alert controller configured to control the notifier such that the notifier alerts the occupant based on a detection result provided from the detector, wherein the alert controller causes the notifier to alert the occupant when the position of the detected object is within alert areas set on both sides of the vehicle, and wherein, when a current road for the vehicle includes a current lane on which the vehicle is traveling, and an adjacent lane adjacent to the current lane or a branching lane branching off from the current lane, the alert controller changes the alert area on a side of the adjacent or branching lane based on a shape of a target road on which the vehicle intends to travel.

### DESCRIPTION

### Technical Field

The present invention relates to a vehicle control system, a vehicle control method, and a non-transitory computer-readable storage medium.

### Background Art

In recent years, active efforts have been made aimed at providing sustainable transportation systems that take into consideration vulnerable persons among traffic participants. To achieve this aim, research and development on autonomous driving technology and driver assistance systems are underway in order to further improve traffic safety and convenience.

An example of such technology aims to alert a driver of a vehicle to objects near the vehicle, thereby providing driving assistance. For example, Patent Document 1 discloses a computer device for displaying images captured by rear-side cameras, which capture the rear-left and rear-right sides of a vehicle, and images captured by side cameras, which capture the left and right sides from the vehicle's side, on a display device. When detecting that the vehicle is approaching an intersection, the computer device switches the images displayed on the display device. Specifically, before detecting that the vehicle is approaching an intersection, the computer device displays the images captured by the rear-side cameras on the display device. Upon detecting that the vehicle is approaching an intersection, the computer device displays both the images captured by the rear-side cameras and those captured by the side cameras on the display device.

### PRIOR ART DOCUMENT (S)

### Patent Document(s)

Patent Document 1: JP2022-521441A

### SUMMARY OF THE INVENTION

### Task to be accomplished by the Invention

In the computer device of Patent Document 1, when it detects that a vehicle is approaching an intersection, both a rear-side image captured by the rear-side camera and left- and right-side images captured by the side cameras are displayed on the display device. As a result, a large amount of information that is not necessary for an occupant of the vehicle to pass through the intersection is displayed on the display device, which makes it difficult for the occupant to easily recognize a situation at the intersection even when looking at the display device. Thus, there is a need for technology that can alert the occupant that an object approaches the vehicle more properly compared to the device of Patent Document 1.

The present invention has been made in view of the problem of the prior art, and one object of the present invention is to provide a vehicle control system for alerting an occupant to the approach of an object to a vehicle, which can properly alert the occupant that an object is approaching a vehicle, thereby promoting further development of sustainable transportation systems.

### Means to Accomplish the Task

As a solution to the above-described task to be accomplished, an aspect of the present invention provides a vehicle control system comprising: a detector configured to detect a position of an object near a vehicle; a notifier configured to alert an occupant in the vehicle; and an alert controller configured to control the notifier such that the notifier alerts the occupant based on a detection result provided from the detector, wherein the alert controller causes the notifier to alert the occupant when the position of the object detected by the detector is within alert areas set on left and right sides of the vehicle, and wherein, when a current road on which the vehicle is traveling includes a current lane on which the vehicle is currently traveling, and an adjacent lane adjacent to the current lane or a branching lane branching off from the current lane, the alert controller changes the alert area on a side of the adjacent lane or the branching lane based on a shape of a target road on which the vehicle intends to travel. Another aspect of the present invention provides a vehicle control method for controlling the vehicle control system. Yet another aspect of the present invention provides a vehicle control program which causes a computer to perform the vehicle control method. Yet another aspect of the present invention provides a non-transitory computer-readable storage medium storing the vehicle control program.

### EFFECT OF THE INVENTION

The above-described embodiment of the present invention is to provide a vehicle control system for alerting an occupant in a vehicle to the approach of an object to the vehicle, which can properly alert the occupant that an object is approaching the vehicle.

### BRIEF DESCRIPTION OF THE DRAWINGS

FIG. 1 is a block diagram showing a general configuration of a vehicle provided with a vehicle control system according to an embodiment of the present invention;

FIG. 2 is a diagram showing the arrangement and detection areas of sensors of the detector provided on the vehicle according to the embodiment;

FIG. 3 is a diagram showing alert areas set when a vehicle is traveling at and around a fork;

FIG. 4 is a diagram showing alert areas set when a vehicle is traveling at and around a fork;

FIG. 5 is a diagram showing alert areas set when a vehicle is traveling at and around an intersection;

FIG. 6 is a diagram showing alert areas set when a vehicle is traveling at and around an intersection;

FIG. 7 is a diagram showing alert areas set when a vehicle is traveling along a curve;

FIG. 8 is a flowchart of a current road recognition operation;

FIG. 9 is a flowchart of an alert area change operation; and

FIG. 10 is a flowchart of an alert operation.

### DESCRIPTION OF THE PREFERRED EMBODIMENT(S)

Embodiments of a vehicle control system 1 of the present invention will be described with reference to the appended drawings. In the drawings and the following description, direction-indicating terms such as front, rear, left and right refer to their corresponding directions of a vehicle 3 provided with the vehicle control system 1. The user vehicle 3 provided with the vehicle control system 1 is also referred to as "user vehicle 3."

### Vehicle 3

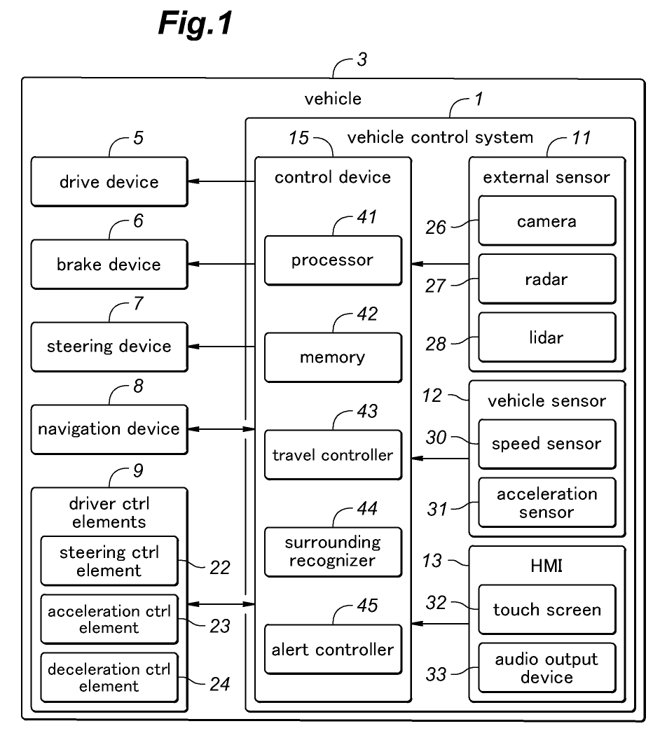

FIG. 1 is a block diagram showing a general configuration of a vehicle 3 provided with a vehicle control system 1. For example, the user vehicle 3 is an automobile. In other embodiments, the user vehicle 3 may be a vehicle other than an automobile (e.g., a two-wheeled vehicle).

As shown in FIG. 1, the user vehicle 3 includes a drive device 5, a brake device 6, a steering device 7, a navigation device 8, driver control elements 9, an external sensor 11, a vehicle sensor 12, an HMI 13 (Human Machine Interface), and a control device 15. The external sensor 11 is an example of a detector that detects the positions of objects present around or near the user vehicle 3. The HMI 13 is an example of a notifier that alerts an occupant of the user vehicle 3. The vehicle control system 1 of the present embodiment comprises a detector (external sensor 11), the vehicle sensor 12, a notifier (HMI 13), and the control device 15.

The drive device 5 is a device that provides driving force to the user vehicle 3. The drive device 5 includes a drive source that generates driving force to propel the user vehicle 3. For example, the drive source is configured by an internal combustion engine and/or an electric motor.

The brake device 6 is a device that provides braking force to the user vehicle 3. For example, the brake device 6 includes brake calipers that press pads against brake rotors, and electric cylinders that supply hydraulic pressure to the brake calipers.

The steering device 7 is a device that turns the wheels to change the steering angle thereof. For example, the steering device 7 includes a rack-and-pinion mechanism connected to the wheels and an electric motor that drives the rack-and-pinion mechanism.

The navigation device 8 is a device that provides routing information regarding travel to a destination for the user vehicle 3. The navigation device 8 stores map information. The navigation device 8 determines the current position of the user vehicle 3 based on GNSS signals (e.g., GPS signals) received from satellites. The navigation device 8 generates a route plan for the user vehicle 3. The navigation device 8 can display the current position of the user vehicle 3, the route plan, and a map of an area at and around the user vehicle 3 on a touch screen 32 described later.

The driver control elements 9 are devices that receive driving operations performed by an occupant in the user vehicle 3 (hereinafter referred to simply as "occupant"). The driver control elements 9 include: a steering control element 22 (e.g., steering wheel) that receives steering operations performed by the occupant in the user vehicle 3; an acceleration control element 23 (e.g., accelerator pedal) that receives acceleration operations performed by the occupant in the user vehicle 3; and a deceleration control element 24 (e.g., brake pedal) that receives deceleration operations performed by the occupant in the user vehicle 3.

The external sensor 11 is a device that acquires information about surroundings of the user vehicle 3. The external sensor 11 includes a plurality of cameras 26, a plurality of radars 27, and a plurality of lidars 28 (LiDARs). Each of the cameras 26 captures images containing objects present near the user vehicle 3 such as nearby vehicles (including a vehicle ahead), motorcycles, and pedestrians, and road components indicating the road's shape such as lane markings. Each of the radars 27 emits radio waves, such as millimeter electromagnetic waves, to surroundings of the user vehicle 3 and detects the positions of objects present near the user vehicle 3 by acquiring the reflected electromagnetic waves. Each of the lidars 28 irradiates the surroundings of the user vehicle 3 with light, such as infrared light, and detects the positions of objects present near the user vehicle 3 by acquiring the reflected light.

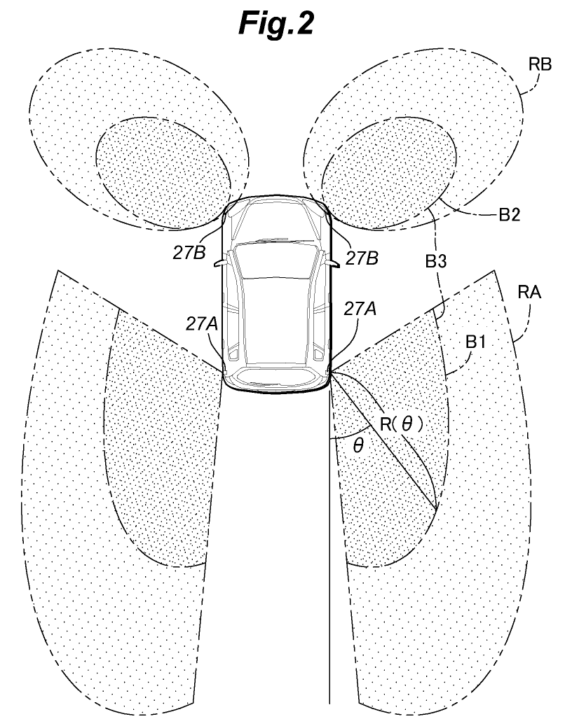

FIG. 2 shows the arrangement and detection areas of the radars 27 (detector) provided on the user vehicle 3. As shown in FIG. 2, the plurality of radars 27 included in the external sensor 11 comprise: left and right first radars 27A (first sensors) provided on the left and right sides at the rear of the user vehicle 3, and left and right second radars 27B (second sensors) provided on the left and right sides (in front of the left and right first radars 27A) at the front of the user vehicle 3. The left and right first radars 27A and the left and right second radars 27B detect the positions of objects. In the following description, an example in which the vehicle control system 1 detects the position of an object by using the plurality of radars 27 will be described. The vehicle control system 1 may detect the position of an object using one or more of the plurality of cameras 26, plurality of radars 27, or plurality of lidars 28.

The vehicle sensor 12 shown in FIG. 1 is a sensor device that detects the traveling state of the user vehicle 3. The vehicle sensor 12 includes a speed sensor 30 that detects the speed of the user vehicle 3, and an acceleration sensor 31 that detects the acceleration and deceleration of the user vehicle 3.

The HMI 13 is a device that alerts an occupant and receives the occupant's input operations. The HMI 13 includes the touch screen 32, an audio output device 33, and an indicator (display device, not shown). The indicator (display device) may be installed in or around a side mirror. The touch screen 32 displays various screens to the occupant and receives the occupant's input operations on these screens. The audio output device 33 outputs audio assist information, warning sounds, and similar audio information.

### Control Device 15

The control device 15 is a computer including a processor 41 and a memory 42 communicatively connected to the processor 41. The processor 41 may include, for example, at least one of a CPU, GPU, or MPU as a core element. The memory 42 stores programs that are executable by the processor 41 and various data. The memory 42 may include at least one of volatile memory and non-volatile memory. The volatile memory may be, for example, DRAM or SRAM. The non-volatile memory may be an SSD, flash memory, magnetic disk storage device, or optical disk storage device. At least part of the control device 15 may be implemented by hardware such as LSI, ASIC, or FPGA, or by a combination of software and hardware. The control device 15 may be configured by a single piece of hardware or by a plurality of pieces of hardware capable of communicating with each other.

The control device 15 includes a travel controller 43, a surrounding recognizer 44, and an alert controller 45 as functional units. The processor 41 implements the travel controller 43, surrounding recognizer 44, and alert controller 45 by executing programs stored in the memory 42. The memory 42 may function as a non-transitory computer-readable storage medium storing a vehicle control program which causes the control device 15 (computer) to perform a vehicle control method for controlling the vehicle control system 1.

The travel controller 43 controls the traveling of the user vehicle 3 in response to the driver's driving operations on the driver control elements 9. For example, the travel controller 43 controls the steering device 7 in response to the driver's steering operations on the steering control element 22 for steering the user vehicle 3, causing the user vehicle 3 to turn. The travel controller 43 controls the drive device 5 in response to the driver's accelerating operations on the acceleration control element 23 for accelerating the user vehicle 3, causing the user vehicle 3 to accelerate. The travel controller 43 controls the brake device 6 in response to the driver decelerating operations on the deceleration control element 24 for decelerating the user vehicle 3, causing the user vehicle 3 to decelerate. Furthermore, when controlling the steering device 7 to turn the user vehicle 3, the travel controller 43 performs turn signal controls, such as activating the turn signals.

The surrounding recognizer 44 recognizes a situation of surroundings of the user vehicle 3 based on information acquired by the external sensor 11. For example, the surrounding recognizer 44 detects the positions of objects (such as other vehicles and pedestrians) present in front of the user vehicle 3 based on detection results provided from the external sensor 11. Furthermore, the surrounding recognizer 44 detects the shape of a road surrounding the user vehicle 3 based on detection results provided from the external sensor 11.

The alert controller 45 performs an alert operation to prompt the HMI 13 to alert an occupant when the position of an object detected using the external sensor 11 is within an alert area(s) D. Furthermore, the alert controller 45 performs a current road recognition operation and an alert area change operation to modify (change) the alert area(s) D based on the shape of a current road, i.e., the road on which the user vehicle 3 is traveling. During the current road recognition operation, the alert controller 45 determines whether it is necessary to change the alert area D based on the shape of a target road, i.e., a road on which the user vehicle 3 intends to travel. Then, when determining that the alert area(s) D needs to be changed during the current road recognition operation, the alert controller 45 performs the alert area change operation to change the alert area(s) D based on the shape of the target road on which the user vehicle 3 intends to travel. How the alert controller 45 can set the alert area D on each side will be described below.

### Setting of Alert Area D

As shown in FIG. 2, the alert controller 45 can set, as an alert area(s) D, any area(s) contained within left and right first detection areas RA where the left and right first radars 27A can detect the positions of objects, and left and right second detection areas RB where the left and right second radars 27B can detect the positions of objects. For example, the alert controller 45 can set, as the alert area D on each side, an area (e.g., first area B1) within the first detection area RA detectable by the corresponding first radar 27A. The alert controller 45 can also set, as the alert area D on each side, an area (e.g., second area B2) within the second detection area RB detectable by the corresponding second radar 27B. Furthermore, the alert controller 45 can set, as the alert areas D on each side, second areas B3, which include an area within the first detection area RA (e.g., first area B1) and an area within the second detection area RB (e.g., area B2).

The alert controller 45 can set, as the alert area D on each side, areas within the distance threshold R(θ) from the first radars 27A or the second radars 27B. The distance threshold R(θ) may be a function of angle θ that varies according to the angle θ relative to a front-rear direction, i.e., a longitudinal direction of the user vehicle 3. The distance threshold R(θ) defines the boundary of the alert area D. The alert controller 45 can modify the alert area D by changing the distance threshold R(θ). For example, the alert controller 45 can increase the distance threshold R(θ) to expand the alert area D. Furthermore, the alert controller 45 can decrease the distance threshold R(θ) to reduce the alert area D.

### Change of Alert Area D

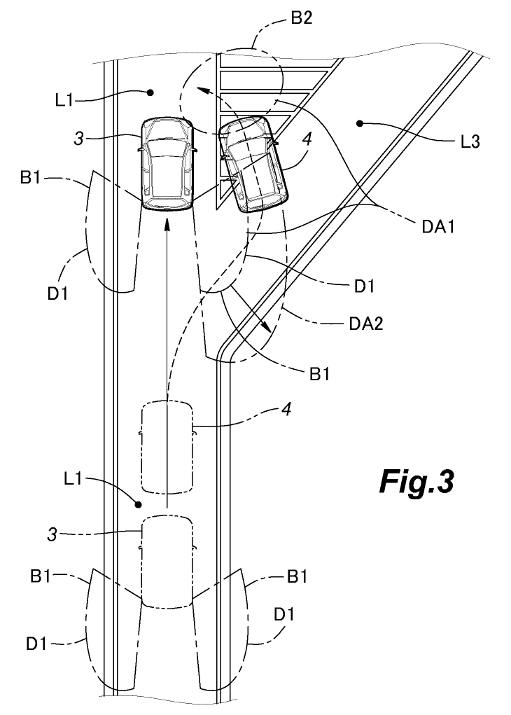

A lane adjacent to and extending in the same direction as a current lane L1, on which a user vehicle 3 is traveling, is referred to as "an adjacent lane L2." A lane branching from the current lane L1 at a fork is referred to as "a branching lane L3" (see FIG. 3).

When a current road, on which the user vehicle 3 is traveling, includes a current lane L1 and either an adjacent lane L2 or branching lane L3, and a target road, on which the user vehicle 3 intends to travel, is a "direction-changeable road" which can extend in a different direction from the current road, the alert controller 45 changes an alert area D based on the shape of the target road, on which the user vehicle 3 intends to travel. Such direction-changeable roads include a fork, an intersection, and a curve.

When a user vehicle 3 is traveling on a road that continues in one direction without bending or curving (i.e., a straight road), the alert controller 45 sets, as an alert area D on each side, a first area B1 (also referred to as "normal alert area D1") contained within the first detection area RA of the corresponding one of the first radars 27A (first sensors).

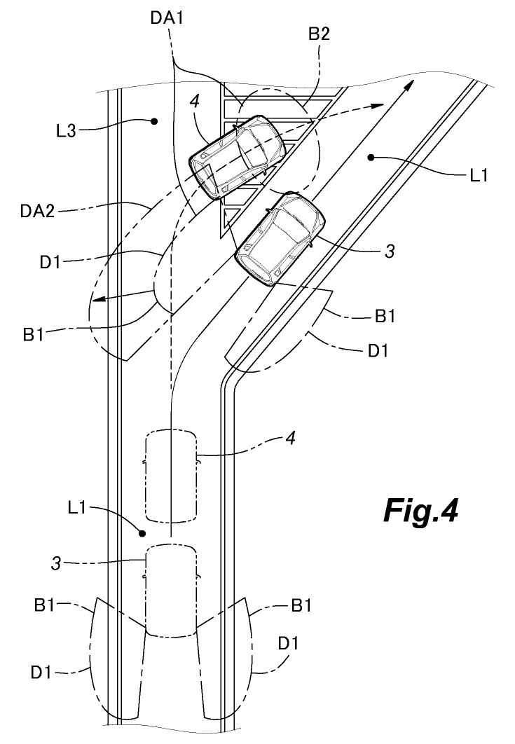

FIGS. 3 and 4 are diagrams showing the alert area D on one side set at the fork. As shown in FIGS. 3 and 4, another vehicle 4 traveling ahead of the user vehicle 3 on the current lane L1 may travel along a branching lane L3 at the branching point and then change its course back to the current lane L1. In this case, because the other vehicle 4 that was traveling in front of the user vehicle 3 temporarily traveled along the branching lane L3, the other vehicle 4 may travel alongside or diagonally ahead of the user vehicle 3 on the side where the branching lane L3 is present (referred to as the "branching lane side"). Thus, when the user vehicle 3 travels through the fork, the alert controller 45 modifies the alert area D on the branching lane side as described below.

When the user vehicle 3 is traveling on a fork, the alert controller 45 may change an alert area D on the branching lane side from a normal alert area D1 (first area B1 included within the first detection area RA of the corresponding first radar 27A) to an alert area DA1 (second area). In this case, the alert controller 45 changes the alert area D by switching the selection between the normal alert area D1 (first area B1) and the alert area DA1 (second area). By changing the alert area D from the normal alert area D1 to the alert area DA1, the alert controller 45 expands the alert area D so as to increase its area.

The alert controller 45 may, at the fork, change the alert area D on the branching lane side from the normal alert area D1 before passing the fork's branching point to an alert area (not shown) that includes part of an area B2 located ahead of the normal alert area D1, without changing its area size. The alert controller 45 may, at the fork, expand the alert area D by changing the alert area from the normal alert area D1 to an alert area DA2 with an increased distance threshold R(θ) on the branching lane side.

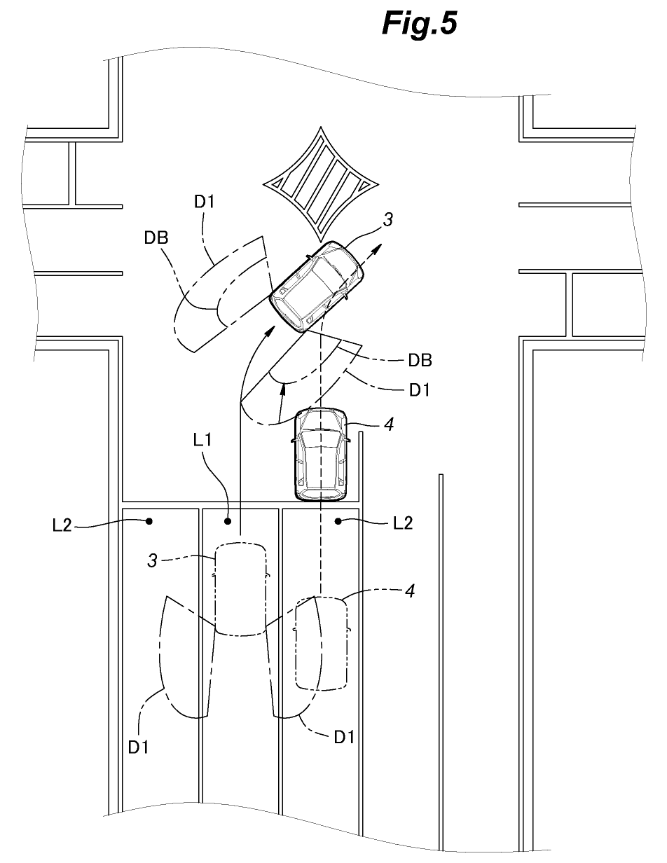

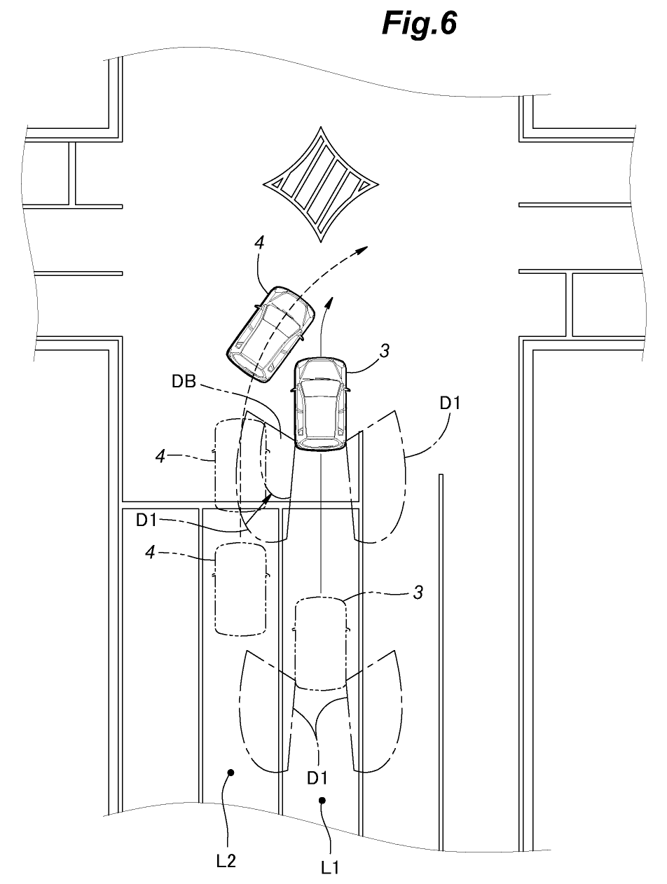

FIGS. 5 and 6 show an alert area D on each side that changes at an intersection. In the intersection shown in FIGS. 5 and 6, the current road the user vehicle 3 travels before entry to the intersection includes an adjacent lane L2. FIGS. 5 and 6 also show an alert area DB on each side of the user vehicle 3 traveling through the intersection when another vehicle 4, which has been traveling on the adjacent lane L2 before entry to the intersection, is traveling alongside the user vehicle 3.

FIG. 5 shows a case where the user vehicle 3 enters the intersection before the other vehicle 4 enters. As shown in FIG. 5, the wheels of the user vehicle 3 are turned at the intersection. The other vehicle 4 may then come close alongside the user vehicle 3. Furthermore, at the intersection, both the user vehicle 3 and the other vehicle 4 reduce their moving speeds. Thus, even when an object such as the other vehicle 4 approaches a side of the user vehicle 3, a contact between the user vehicle 3 and an object such as the other vehicle 4 is less likely to occur. Therefore, for example, at the intersection shown in FIG. 5, when an object such as the other vehicle 4 is located at the boundary of a normal alert area D1 of the user vehicle 3, it can be considered unnecessary to alert an occupant that the object is within the normal alert area D1. When the occupant is alerted that an object is within the normal alert area D1 in this case, the occupant can be excessively alerted to the approach of an object to the user vehicle 3. Furthermore, at intersections or curves, when the wheels are turned, the occupant is alerted by both a visual display and an audible alarm. This alert operation can be excessive.

Therefore, as shown in FIG. 5, the alert controller 45 changes the alert area D on the adjacent lane L2 side from the normal alert area D1 to a reduced alert area DB. Furthermore, the alert controller 45 may refrain from alerting the occupant (e.g., via an alarm sound) when the wheels are turned at an intersection. This feature allows the alert controller 45 to suppress excessive alerts indicating that an object is approaching the user vehicle 3. In other words, the alert controller 45 can properly alert the occupant to an approaching object. It should be noted that the alert controller 45 may also reduce the distance threshold R(θ) on the adjacent lane L2 side to change the alert area D from the normal alert area D1 to the reduced alert area DB.

FIG. 6 shows a situation where the user vehicle 3 enters the intersection after the other vehicle 4 enters there. As shown in FIG. 6, when the wheels of the user vehicle 3 are steered at the intersection, the other vehicle 4 approaches a side of the user vehicle 3. Furthermore, at the intersection, both the user vehicle 3 and the other vehicle 4 reduce their moving speeds. Therefore, even when an object such as the other vehicle 4 approaches a side of the user vehicle 3, a contact between the user vehicle 3 and an object such as the other vehicle 4 is less likely to occur. Therefore, for example, at the intersection shown in FIG. 6, when an object such as the other vehicle 4 is located at the boundary of a normal alert area D1 of the user vehicle 3, it can be considered unnecessary to alert an occupant that the object is within the normal alert area D1. When the occupants are alerted that an object is within the normal alert area D1 in this case, the occupant can be excessively alerted to the approach of an object to the user vehicle 3. Furthermore, at intersections or curves, when the wheels are turned, the occupant is alerted by both a visual display and an audible alarm. This alert can be excessive.

Therefore, as shown in FIG. 6, the alert controller 45 changes the alert area D on the side of the adjacent lane L2 from the normal alert area D1 to a reduced alert area DB. Furthermore, the alert controller 45 may refrain from alerting the occupant (e.g., via an alarm sound) when the wheels are turned at an intersection. This feature allows the alert controller 45 to suppress excessive alerts indicating that an object is approaching the user vehicle 3. In other words, the alert controller 45 can properly alert the occupant to an approaching object. It should be noted that the alert controller 45 may also reduce the distance threshold R(θ) on the adjacent lane L2 side to change the alert area D from the normal alert area D1 to the reduced alert area DB.

As described with reference to FIGS. 5 and 6, when the current road which the user vehicle 3 travels before entry to the intersection includes an adjacent lane L2, the alert controller 45 reduces the alert area D on the side of the adjacent lane L2 of the current road to an alert area DB, which allows the alert controller 45 to suppress excessive alerts indicating that an object such as the other vehicle 4 are approaching the user vehicle 3. In other words, the alert controller 45 can properly alert the occupant when an object is approaching.

FIGS. 5 and 6 show that the user vehicle 3 makes a right turn at the intersection. When the user vehicle 3 makes a left turn at the intersection, the alert controller 45 also changes the alert area D in the same manner as when the user vehicle 3 makes a right turn at the intersection.

In some cases, the current road the user vehicle 3 travels before entry to the intersection includes two adjacent lanes L2 to the left and right of the current road L1. In this case, the alert controller 45 may change each of the left and right alert areas D to an alert area DB, which is reduced from the normal alert area D1. When the user vehicle 3 is on the current road before entry to the intersection and an adjacent lane L2 exists to the left of the current lane L1, the alert controller 45 may change the left alert area D to an alert area DB, which is reduced from the normal alert area D1. When the user vehicle 3 is on the current road before entry to the intersection and an adjacent lane L2 exists to the right of the current lane L1, the alert controller 45 may change the right alert area D to an alert area DB, which is reduced from the normal alert area D1.

When the user vehicle 3 plans to turn right or left at the intersection, the alert controller 45 may reduce the alert area D on the side to which the user vehicle 3 will turn. When the user vehicle 3 plans to travel through the intersection, the alert controller 45 does not need to change the alert area D (typically leaving it unchanged from the alert area D1).

When the current road the user vehicle 3 travels before entry to the intersection includes a right-turn lane as an adjacent lane L2 and the user vehicle 3 plans to make a right turn, the alert controller 45 may regard the side on which the right-turn lane exists as the side of the adjacent lane L2 and change the alert area D on the right-turn lane side from the normal alert area D1 to a reduced alert area DB.

When the current road the user vehicle 3 travels before entry to the intersection includes a left-turn lane as an adjacent lane L2 and the user vehicle 3 plans to make a left turn, the alert controller 45 may regard the side on which the left-turn lane exists as the side of the adjacent lane L2 and change the alert area D on the left-turn lane side from the normal alert area D1 to a reduced alert area DB.

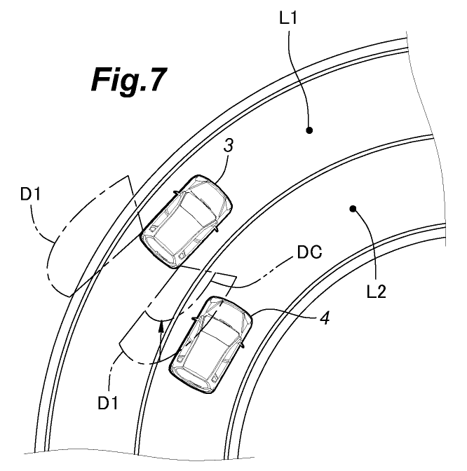

FIG. 7 is a diagram showing an alert area D on each side that changes in a curve including an adjacent lane L2. As shown in FIG. 7, when the user vehicle 3 is traveling on a curve including the adjacent lane L2, the user vehicle 3 and another vehicle 4 traveling on the adjacent lane L2 may become close to each other. When the alert controller 45 does not change the alert areas D in the curve (i.e., uses the normal alert area D1 as an alert area D on each side), the occupant is alerted when an object such as the other vehicle 4 is located at the boundary of one of the normal alert areas D1 of the user vehicle 3. In this case, the occupant can be excessively alerted to the approach of an object to the user vehicle 3.

Therefore, as shown in FIG. 7, when the user vehicle 3 travels along a curve including the adjacent lane L2, the alert controller 45 changes the alert area D on the side of the adjacent lane from the normal alert area D1 to a reduced alert area DC. This feature allows the alert controller 45 to suppress excessive alerts indicating that an object is approaching the user vehicle 3 when the user vehicle is traveling on a curve including an adjacent lane L2. In other words, the alert controller 45 can properly alert the occupant to an approaching object.

### Operations of Alert Controller 45

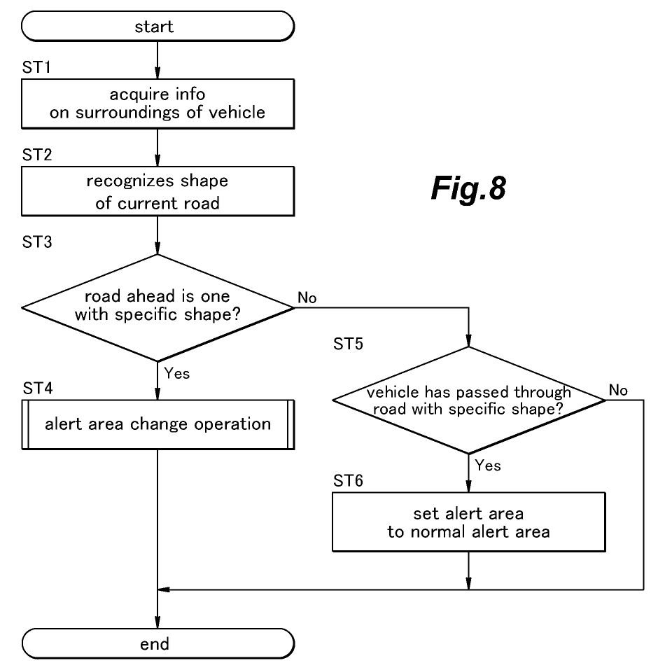

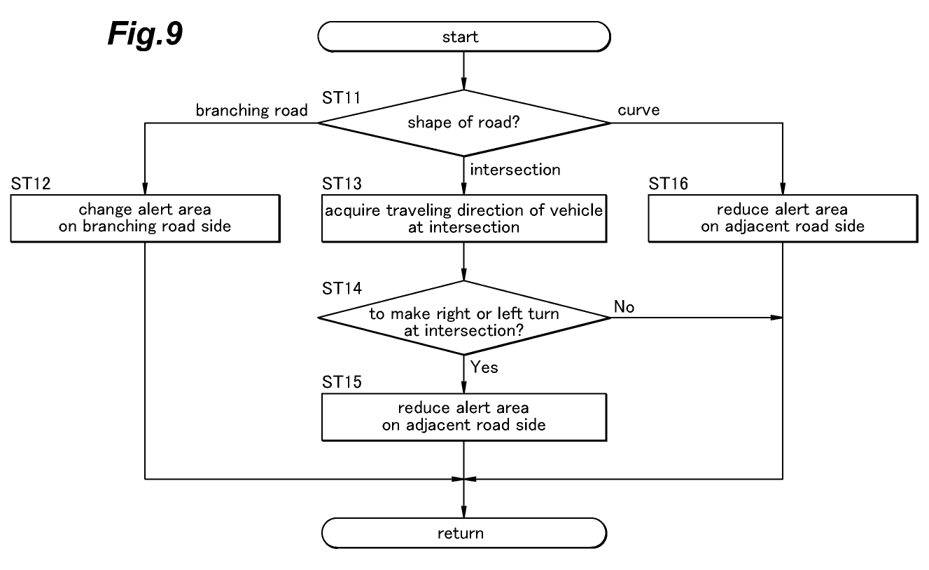

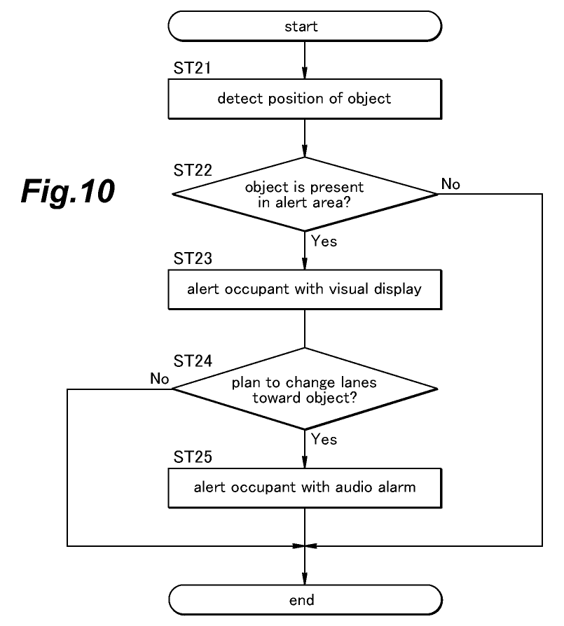

Next, referring to FIGS. 8 to 10, a current road recognition operation (FIG. 8), an alert area change operation (FIG. 9), and an alert operation (FIG. 10) that are performed by the vehicle control system 1 will be described.

### Current Road Recognition Operation

FIG. 8 is a flowchart of the current road recognition operation. When the main power of the user vehicle 3 is turned ON, the vehicle control system 1 performs the current road recognition operation at predetermined time intervals (e.g., 10 ms).

In the current road recognition operation, first, the external sensor 11 acquires information about surroundings of the user vehicle 3 (user vehicle's surrounding information) (Step ST1). Next, the surrounding recognizer 44 recognizes the shapes of roads based on the surrounding information acquired by the external sensor 11 (Step ST2). Specifically, the surrounding recognizer 44 recognizes the shape of a current road on which the user vehicle 3 is currently traveling and the shape of a road ahead in the traveling direction (i.e., a target road on which the user vehicle 3 intends to travel) that is present a predetermined distance ahead of the current road. The surrounding recognizer 44 recognizes the following types of road shapes: straight road, fork and junction, intersection, curve, current lane L1, adjacent lane L2, right-turn lane adjacent to the current lane L1, and left-turn lane adjacent to the current lane L1.

Next, the alert controller 45 determines whether the road ahead in the traveling direction of the user vehicle 3 is a road with a specific road shape based on a recognition result of the surrounding recognizer 44 (Step ST3). A road with a specific road shape refers to a "direction-changeable road", including forks, intersections, and curves containing an adjacent lane L2. When the recognition result from the surrounding recognizer 44 satisfies at least one of the following conditions Q1 to Q3, the alert controller 45 determines that the road ahead in the traveling direction of the user vehicle 3 is a road with a specific road shape (Yes in Step ST3). When the recognition result from the surrounding recognizer 44 does not satisfy any of the following conditions Q1 to Q3, the alert controller 45 determines that the road ahead in the traveling direction of the user vehicle 3 is not a road with a specific road shape (No in Step ST3).

Condition Q1: The road ahead in the traveling direction of the user vehicle 3 is a fork.

Condition Q2: The current road on which the user vehicle 3 currently is traveling includes an adjacent lane L2, and the road ahead in the traveling direction of the user vehicle 3 is an intersection.

Condition Q3: The current road on which the user vehicle 3 currently is traveling includes an adjacent lane L2, and the road ahead in the traveling direction of the user vehicle 3 is a curve.

When determining that the road ahead in the traveling direction of the user vehicle 3 is a road with a specific road shape (Yes in Step ST3), the alert controller 45 performs the alert area change operation to modify the alert area D based on the shape of a target road on which the user vehicle 3 intends to travel (Step ST4).

In Step ST3, when determining that the road ahead in the traveling direction of the user vehicle 3 is not a road with a specific road shape (No in Step ST3), the alert controller 45 determines whether the user vehicle 3 has passed the road with a specific road shape (Step STb). In Step ST5, the alert controller 45 determines whether the following condition Q4 is satisfied. When determining that the following condition Q4 is not satisfied, the alert controller 45 determines that the vehicle has passed through a road with a specific road shape (Yes in Step ST5). When determining that the following condition Q4 is satisfied, the alert controller 45 determines that the vehicle has not passed through a road with a specific road shape (No in Step ST5).

Condition Q4: The user vehicle 3 is currently traveling on a curve that does not include an adjacent lane L2, or is currently traveling on a straight road.

When determining that the user vehicle has passed through a road with a specific shape (Yes in Step ST5), the alert controller 45 sets the alert area D to the normal alert area D1 (Step ST6) and ends the current road recognition operation. When determining that the user vehicle has passed through a road with a specific shape (Yes in Step ST5), the user vehicle 3 is currently traveling on a curve or straight road that does not include an adjacent lane L2, and the alert area D is set to the normal alert area D1 (Step ST6).

When determining that the user vehicle has not passed through a road with a specific shape (No in Step ST5), the alert controller 45 ends the current road recognition operation without changing the alert area D. When determining that the user vehicle has not passed through a road with a specific shape (No in Step ST5), the user vehicle 3 is currently traveling on a road with a specific shape. Before the user vehicle 3 travels on a road with a specific shape, the alert controller 45 performs the operations of Steps ST3 and ST4, thereby changing the alert area D typically to a different area from the normal alert area D1 (e.g., an alert area DA1 or alert area DA2 in FIGS. 3 and 4, an alert area DB in FIGS. 5 and 6, an alert area DC in FIG. 7).

As shown in FIGS. 3 to 7, since the user vehicle 3 is currently traveling on a road with a specific shape, the alert controller 45 needs to maintain the alert area D that has been changed before traveling on the road with the specific shape (i.e., not change the current alert area D). Thus, when determining that the user vehicle has not passed through the road with the specific road shape (No in Step ST5), the alert controller 45 ends the current road recognition operation without changing the alert area D.

When the alert controller 45 determines whether the vehicle has passed through a road with a specific road shape in Step ST5, the basis of the determination may be (i) the detection results from the external sensor 11 (the recognition result from the surrounding recognizer 44), (ii) the current position of the user vehicle 3 identified by the navigation device 8 and map information, or (iii) whether a predetermined time has elapsed or a predetermined distance has been traveled since the alert area D was changed to a different area from the normal alert area D1 during the operation of Step ST4.

### Alert Area Change Operation

FIG. 9 is a flowchart of the alert area change operation. The vehicle control system 1 performs the alert area change operation in Step ST4 of the current road recognition operation as described above with reference to FIG. 8.

In the alert area change operation, first, the alert controller 45 determines whether the shape of a target road on which the user vehicle 3 intends to travel is a fork, intersection, or curve (Step ST11).

In Step ST11, when determining that the shape of a target road on which the user vehicle 3 intends to travel is a fork, the alert controller 45 changes the alert area D on the side of a branching lane L3 from the normal alert area D1, as described above with reference to FIGS. 3 and 4 (Step ST12). As shown in FIGS. 3 and 4, in Step ST12, the alert controller 45 may change the alert area D from the normal alert area D1 to an alert area DA2 within a larger distance threshold R(θ) on the branching lane side, thereby expanding the alert area D. The alert controller 45 may also change the alert area D by switching the selection between the normal alert area D1 (first area B1) and the alert area DA1 (second area B3). Furthermore, the alert controller 45 may expand the alert area D by changing it from the normal alert area D1 to the alert area DA1, thereby increasing the area of the alert area D.

In Step ST11, when determining that the shape of a target road on which the user vehicle 3 intends to travel is an intersection, the alert controller 45 acquires the traveling direction of the user vehicle 3 at the intersection based on the control of the travel controller 43 or the route plan generated by the navigation device 8 (Step ST13). The alert controller 45 may also acquire the traveling direction of the user vehicle 3 at the intersection based on the control of the steering device 7 from the travel controller 43. The alert controller 45 may also acquire the traveling direction of the user vehicle 3 at the intersection based on the occupant's operation of the turn signal (not shown). Furthermore, the alert controller 45 may acquire the traveling direction of the user vehicle 3 at the intersection based on the route plan for the user vehicle 3 generated by the navigation device 8.

Next, the alert controller 45 determines whether the user vehicle 3 intends to make a right or left turn at the intersection (Step ST14). When determining that the user vehicle 3 intends to travel straight through the intersection (No in Step ST14), the alert controller 45 ends the alert area change operation without modifying the alert area D.

When determining that the user vehicle 3 intends to make a right or left turn at the intersection (Yes in Step ST14), the alert controller 45 changes the alert area D on the side of the adjacent lane L2 from the normal alert area D1 to a reduced alert area DB, as described above with reference to FIGS. 5 and 6 (Step ST15), and ends the alert area change operation.

In some cases, the current road on which the user vehicle 3 travels before entry to the intersection may include an adjacent lane L2 to the left or right of the current lane L1. In this case, in Step ST15, the alert controller 45 may change the left or right alert area D to an alert area DB, which is reduced from the normal alert area D1. When the current road on which the user vehicle 3 travels before entry to the intersection includes an adjacent lane L2 to the left of the current lane L1, in Step ST15, the alert controller 45 may change the left alert area D to an alert area DB, which is reduced from the normal alert area D1. When the current road on which the user vehicle 3 travels before entry to the intersection includes an adjacent lane L2 to the right of the current lane L1, in Step ST15, the alert controller 45 may change the right alert area D to an alert area DB, which is reduced from the normal alert area D1.

When the current road, on which the user vehicle 3 travels before entry to the intersection, includes a right-turn lane as an adjacent lane L2 and the user vehicle 3 intends to make a right turn, in Step ST15, the alert controller 45 may determine that the side on which the right-turn lane is present is the side on which the adjacent lane L2 is present, and change the alert area D on the right-turn lane side from the normal alert area D1 to a reduced alert area DB.

When the current road, on which the user vehicle 3 travels before entry to the intersection, includes a left-turn lane as an adjacent lane L2 and the user vehicle 3 intends to make a left turn, in Step ST15, the alert controller 45 may determine that the side on which the left-turn lane is present is the side on which the adjacent lane L2 is present, and change the alert area D on the left-turn lane side from the normal alert area D1 to a reduced alert area DB.

In Step ST11, when determining that the shape of a target road on which the user vehicle 3 intends to travel is a curve, the alert controller 45 changes the alert area D on the side of a branching lane L3 to an alert area DC, which is reduced from the normal alert area D1, as described above with reference to FIG. 7 (Step ST16), and ends the alert area change operation. As shown in FIG. 7, when the user vehicle 3 travels along a curve including the adjacent lane L2, in Step ST16, the alert controller 45 changes the alert area D on the adjacent lane side to an alert area DC, which is reduced from the normal alert area D1.

### Alert Operation

FIG. 10 is a flowchart of the alert operation. When the main power of the user vehicle 3 is turned ON, the vehicle control system 1 performs the alert operation at predetermined time intervals (e.g., 10 ms).

In the alert operation, first, the external sensor 11 acquires information about the surroundings of the user vehicle 3, and the surrounding recognizer 44 then detects the position of an object around the user vehicle 3 based on the surrounding information acquired by the external sensor 11 (Step ST21).

Next, the alert controller 45 determines whether an object is present within the alert area D based on the object's position detected in Step ST21 (Step ST22). When determining that no object is present within the alert area D (No in Step ST22), the alert controller 45 ends the alert operation.

When determining that an object is present within the alert area D (Yes in Step ST22), the alert controller 45 alerts the occupant with a visual display on the touch screen 32 of the HMI 13 (Step ST23) and determines whether the user vehicle 3 plans to change lanes toward the object (Step ST24). In Step ST23, the alert controller 45 may display an icon indicating the object on the touch screen 32 or an indicator (display device). In Step ST24, the alert controller 45 may detect the current lane change which the user vehicle 3 has made based on the control of the travel controller 43 or the route plan generated by the navigation device 8, and determine whether the user vehicle 3 intends to change lanes toward the object.

When determining that the user vehicle 3 does not intend to change lanes toward the object (No in Step ST24), the alert controller 45 ends the alert operation.

When determining that the user vehicle 3 intends to change lanes toward the object (Yes in Step ST24), the alert controller 45 causes the HMI 13 to produce an audio alarm (Step ST25) and ends the alert operation. In Step ST25, the alert controller 45 may generate an alarm sound from the audio output device 33.

### EFFECT OF THE INVENTION

The effect achieved by the vehicle control system 1 will be described.

When a current road on which the user vehicle 3 is traveling includes a current lane L1 on which the vehicle is currently traveling, and an adjacent lane L2 adjacent to the current lane L1 or a branching lane L3 branching off from the current lane L1 (Yes in Step ST3), the alert controller 45 changes the alert area D on a side of the adjacent lane L2 or the branching lane L3 based on a shape of a target road on which the user vehicle 3 intends to travel.

This configuration enables the alert controller 45 to change the alert area D to a proper alert area D, which provides a vehicle control system 1 for alerting an occupant to the approach of an object to a vehicle, which can properly alert an occupant the approach of an object to a vehicle.

The alert controller 45 sets areas within a distance threshold R(θ) from the detector as the alert areas D and changes the alert areas by changing the distance threshold R(θ) (Step ST12). This enables the alert controller 45 to easily modify the alert area D.

The alert controller 45 is capable of selecting, as the alert areas D, either first areas B1 included within detection areas RA of the left and right first radars 27A (first sensors), or second areas B3 included within detection areas RA of the left and right first radars 27A (first sensors) and the left and right second radars 27B (second sensors), and configured to change the alert areas D to a proper alert area D by switching the selection between the first areas B1 and the second areas B3 (Step ST12). This enables the alert controller 45 to change the alert area D to a proper alert area D.

When the current road the user vehicle 3 is traveling includes a current lane L1 and an adjacent lane L2 adjacent to the current lane L1 or a branching lane L3 branching off from the current lane L1, and the shape of the target road is a fork, intersection, or curve (Yes in Step ST3), the alert controller 45 changes the alert area D on a side of the adjacent lane L2 or the branching lane L3 based on the shape of a target road on which the user vehicle 3 intends to travel (Steps ST12, ST15, ST16). This enables the alert controller 45 to change the alert area D to a proper alert area D.

When the shape of the target road on which the user vehicle 3 intends to travel is the fork, the alert controller 45 changes the alert area D on the side of the branching lane L3 branching off from the current lane L1 to a second area B3 including an area B2 in front of the current alert area (Step ST12). This enables the alert controller 45 to change the alert area D to a proper alert area D at the fork.

When the shape of the target road on which the user vehicle 3 intends to travel is the fork, the alert controller 45 expands the alert area D on the side of the branching lane L3 branching off from the current lane L1 so as to increase the area size thereof (Step ST12). This enables the alert controller 45 to change the alert area D to a proper alert area D at the fork.

When the shape of the target road on which the user vehicle 3 intends to travel is the fork, the alert controller 45 expands the alert area D on the side of the branching lane L3 branching off from the current lane L1. This enables the alert controller 45 to change the alert area D to a proper alert area D at the fork.

When the shape of the target road on which the user vehicle 3 intends to travel is the intersection, the current road includes the current lane L1 and the adjacent lane L2, and the vehicle intends to turn right or left at the intersection (Yes in Step ST14), the alert controller 45 reduces the alert area on the side of the adjacent lane L2. This enables the alert controller 45 to change the alert area D to a proper alert area D at the intersection.

When the shape of the target road on which the user vehicle 3 intends to travel is the intersection and the current road includes the current lane L1 and the adjacent lane, the adjacent lane being a right-turn lane, and the vehicle intends to turn right at the intersection (Yes in Step ST14), the alert controller 45 reduces the alert area D on the side of the right-turn lane. This enables the alert controller 45 to change the alert area D to a proper alert area D at the intersection.

When the shape of the target road on which the user vehicle 3 intends to travel is the intersection and the current road includes the current lane L1 and the adjacent lane, the adjacent lane being a left-turn lane, and the user vehicle 3 intends to turn left at the intersection (Yes in Step ST14), the alert controller 45 reduces the alert area D on the side of the left-turn lane. This enables the alert controller 45 to change the alert area D to a proper alert area D at the intersection.

When the shape of the target road on which the user vehicle 3 intends to travel is the intersection and the user vehicle 3 intends to travel straight through the intersection, the alert controller 45 does not change the alert areas D. This enables the alert controller 45 to set the alert area D to a proper alert area D at the intersection.

When the shape of the target road on which the user vehicle 3 intends to travel is the curve and the current road includes the current lane L1 and the adjacent lane L2, the alert controller 45 reduces the alert area D on the side of the adjacent lane. This enables the alert controller 45 to set the alert area D to a proper alert area D at the curve.

The alert controller 45 causes the HM1 13 to alert the occupant by a visual alert (Step ST23), and also causes the HM113 to alert the occupant by a sound alert (Step ST25). This enables the alert controller 45 to properly alert the occupant to an object.

The above embodiments of the present invention may be described as follows.

In some embodiments, a vehicle control system 1 comprises: an external sensor 11 (detector) for detecting a position of an object near a user vehicle 3; an HMI 13 (notifier) for alerting an occupant in the user vehicle 3; and an alert controller 45 for controlling the HMI 13 such that the HMI 13 alerts the occupant based on a detection result provided from the external sensor 11, wherein the alert controller 45 causes the HMI 13 to alert the occupant (Step ST23) when the position of the object detected by the external sensor 11 is within alert areas D set on left and right sides of the user vehicle 3 (Yes in Step ST22), and wherein, when a current road on which the user vehicle 3 is traveling includes a current lane L1 on which the user vehicle 3 is currently traveling, and an adjacent lane L2 adjacent to the current lane L1 or a branching lane L3 branching off from the current lane L1 (Yes in Step ST3), the alert controller 45 changes the alert area D on a side of the adjacent lane L2 or the branching lane L3 based on a shape of a target road on which the user vehicle 3 intends to travel (Step ST4).

This configuration enables the alert controller 45 to change the alert area D to a proper alert area D, that is, can provide a vehicle control system 1 for alerting an occupant to the approach of an object to a vehicle, which can properly alert an occupant to the approach of an object to a vehicle.

In some embodiments, the alert controller sets areas within a distance threshold R(θ) from the detector as the alert areas D and changes the alert areas by changing the distance threshold R(θ) (Step ST12).

This configuration enables the alert controller 45 to easily modify the alert area D.

In some embodiments, the external sensor 11 includes: left and right first radars 27A (first sensors) which are installed on the left and right sides of the user vehicle 3, for detecting the position of the object; and left and right second radars 27B (second sensors) which are installed in front of the left and right first sensors, for detecting the position of the object, wherein the alert controller 45 is capable of selecting, as the alert areas D, either first areas B1 included within detection areas RA of the left and right first radars 27A (first sensors), or second areas B3 included within detection areas RA of the left and right first radars 27A (first sensors) and the left and right second radars 27B (second sensors), and configured to change the alert areas D to a proper alert area D by switching the selection between the first areas B1 and the second areas B3 (Step ST12).

This configuration enables the alert controller 45 to change the alert area D to a proper alert area D.

In some embodiments, when the current road the user vehicle 3 is traveling includes a current lane L1 and an adjacent lane L2 adjacent to the current lane L1 or a branching lane L3 branching off from the current lane L1, and the shape of the target road is a fork, intersection, or curve (Yes in Step ST3), the alert controller 45 changes the alert area D on a side of the adjacent lane L2 or the branching lane L3 based on the shape of a target road on which the user vehicle 3 intends to travel (Steps ST12, ST15, ST16).

This configuration enables the alert controller 45 to change the alert area D to a proper alert area D.

In some embodiments, when the shape of the target road on which the user vehicle 3 intends to travel is the fork, the alert controller 45 changes the alert area D on the side of the branching lane L3 branching off from the current lane L1 to a second area B3 including an area B2 in front of the current alert area (Step ST12).

This configuration enables the alert controller 45 to change the alert area D to a proper alert area D at the fork.

In some embodiments, when the shape of the target road on which the user vehicle 3 intends to travel is the fork, the alert controller 45 expands the alert area D on the side of the branching lane L3 branching off from the current lane L1 so as to increase the area size thereof (Step ST12).

This configuration enables the alert controller 45 to change the alert area D to a proper alert area D at the fork.

In some embodiments, when the shape of the target road on which the user vehicle 3 intends to travel is the fork, the alert controller 45 expands the alert area D on the side of the branching lane L3 branching off from the current lane L1.

This configuration enables the alert controller 45 to change the alert area D to a proper alert area D at the fork.

In some embodiments, when the shape of the target road on which the user vehicle 3 intends to travel is the intersection, the current road includes the current lane L1 and the adjacent lane L2, and the vehicle intends to turn right or left at the intersection (Yes in Step ST14), the alert controller 45 reduces the alert area on the side of the adjacent lane L2.

This configuration enables the alert controller 45 to change the alert area D to a proper alert area D at the intersection.

In some embodiments, when the shape of the target road on which the user vehicle 3 intends to travel is the intersection and the current road includes the current lane L1 and the adjacent lane, the adjacent lane being a right-turn lane, and the vehicle intends to turn right at the intersection (Yes in Step ST14), the alert controller 45 reduces the alert area D on the side of the right-turn lane.

This configuration enables the alert controller 45 to change the alert area D to a proper alert area D at the intersection.

In some embodiments, when the shape of the target road on which the user vehicle 3 intends to travel is the intersection and the current road includes the current lane L1 and the adjacent lane, the adjacent lane being a left-turn lane, and the user vehicle 3 intends to turn left at the intersection (Yes in Step ST14), the alert controller 45 reduces the alert area D on the side of the left-turn lane.

This configuration enables the alert controller 45 to change the alert area D to a proper alert area D at the intersection.

In some embodiments, when the shape of the target road on which the user vehicle 3 intends to travel is the intersection and the user vehicle 3 intends to travel straight through the intersection, the alert controller 45 does not change the alert areas D.

This configuration enables the alert controller 45 to set the alert area D to a proper alert area D at the intersection.

In some embodiments, when the shape of the target road on which the user vehicle 3 intends to travel is the curve and the current road includes the current lane L1 and the adjacent lane L2, the alert controller 45 reduces the alert area D on the side of the adjacent lane.

This configuration enables the alert controller 45 to set the alert area D to a proper alert area D at the curve.

In some embodiments, when the position of the object detected by the external sensor 11 is within the alert area D on the left or right side of the user vehicle 3 (Yes in Step ST22), the alert controller 45 causes the HMI 13 to alert the occupant by a visual alert (Step ST23), and when the position of the object detected by the external sensor 11 is within the alert area D on the left or right side of the user vehicle 3 and the user vehicle 3 intends to change lanes by a driver's operation toward the left or right side where the object is present (Yes in Step ST24), the alert controller 45 causes the HMI 13 to alert the occupant by a sound alert (Step ST25).

This configuration enables the alert controller 45 to properly alert the occupant to an object.

In some embodiments, there is provided a vehicle control method for controlling the vehicle control system 1, wherein the vehicle control system 1 (alert system) comprises the external sensor 11 (detector), the HMI 13 (notifier), and the alert controller 45, wherein the method comprises the alert controller 45 performing operations to: cause the HMI 13 (notifier) to alert the occupant (Step ST23) when the position of the object detected by the external sensor 11 (detector) is within alert areas D set on left and right sides of the user vehicle 3 (Yes in Step ST22), and, when a current road on which the user vehicle 3 is traveling includes a current lane L1 on which the user vehicle 3 is currently traveling, and an adjacent lane L2 adjacent to the current lane L1 or a branching lane L3 branching off from the current lane L1 (Yes in Step ST3), change the alert area D on a side of the adjacent lane L2 or the branching lane L3 based on a shape of a target road on which the user vehicle 3 intends to travel (Step ST4).

In some embodiments, there is provided a non-transitory computer-readable storage medium stores a vehicle control program which causes the control device 15 (computer) to control the vehicle control system 1, wherein the vehicle control program causes the alert controller 45 to perform operations to: cause the HMI 13 (notifier) to alert the occupant (Step ST23) when the position of the object detected by the external sensor 11 (detector ) is within alert areas D set on left and right sides of the user vehicle 3 (Yes in Step ST22), and, when a current road on which the user vehicle 3 is traveling includes a current lane L1 on which the user vehicle 3 is currently traveling, and an adjacent lane L2 adjacent to the current lane L1 or a branching lane L3 branching off from the current lane L1 (Yes in Step ST3), change the alert area D on a side of the adjacent lane L2 or the branching lane L3 based on a shape of a target road on which the user vehicle 3 intends to travel (Step ST4).

The present invention has been described in terms of specific embodiments. However, it is not limited by such embodiments, and can be embodied with various modifications.

1. A vehicle control system comprising:
a detector configured to detect a position of an object near a vehicle;
a notifier configured to alert an occupant in the vehicle; and
an alert controller configured to control the notifier such that the notifier alerts the occupant based on a detection result provided from the detector,
wherein the alert controller causes the notifier to alert the occupant when the position of the object detected by the detector is within alert areas set on left and right sides of the vehicle, and
wherein, when a current road on which the vehicle is traveling includes a current lane on which the vehicle is currently traveling, and an adjacent lane adjacent to the current lane or a branching lane branching off from the current lane, the alert controller changes the alert area on a side of the adjacent lane or the branching lane based on a shape of a target road on which the vehicle intends to travel.

2. The vehicle control system as claimed in claim 1, wherein the alert controller sets areas within a distance threshold from the detector as the alert areas, and changes the alert areas by changing the distance threshold.

3. The vehicle control system as claimed in claim 1, wherein the detector includes:
left and right first sensors which are installed on the left and right sides of the vehicle and configured to detect the position of the object; and
left and right second sensors which are installed in front of the left and right first sensors and configured to detect the position of the object,
wherein the alert controller is capable of selecting, as the alert areas, either first areas included within detection areas of the left and right first sensors, or second areas included within detection areas of the left and right first sensors and the left and right second sensors, and configured to change the alert areas by switching the selection between the first areas and the second areas.

4. The vehicle control system as claimed in claim 1, wherein, when the current road includes the current lane and the adjacent lane or the branching lane, and the shape of the target road is a fork, intersection, or curve, the alert controller changes the alert area on a side of the adjacent lane or the branching lane based on the shape of the target road.

5. The vehicle control system as claimed in claim 1, wherein, when the shape of the target road is the fork, the alert controller changes the alert area on the side of the branching lane to new alert areas including an area in front of the current alert area.

6. The vehicle control system as claimed in claim 5, wherein, when the shape of the target road is the fork, the alert controller expands the alert area on the side of the branching lane so as to increase the area size thereof.

7. The vehicle control system as claimed in claim 1, wherein, when the shape of the target road is the fork, the alert controller expands the alert area on the side of the branching lane.

8. The vehicle control system as claimed in claim 1, wherein, when the shape of the target road is the intersection, the current road includes the current lane and the adjacent lane, and the vehicle intends to turn right or left at the intersection, the alert controller reduces the alert area on the side of the adjacent lane.

9. The vehicle control system as claimed in claim 8, wherein, when the shape of the target road is the intersection and the current road includes the current lane and the adjacent lane, the adjacent lane being a right-turn lane, and the vehicle intends to turn right at the intersection, the alert controller reduces the alert area on the side of the right-turn lane.

10. The vehicle control system as claimed in claim 8, wherein, when the shape of the target road is the intersection, the current road includes the current lane and the adjacent lane, the adjacent lane being a left-turn lane, and the vehicle intends to turn left at the intersection, the alert controller reduces the alert area on the side of the left-turn lane.

11. The vehicle control system as claimed in claim 8, wherein, when the shape of the target road is the intersection and the vehicle intends to travel straight through the intersection, the alert controller does not change the alert areas.

12. The vehicle control system as claimed in claim 1, wherein, when the shape of the target road is the curve and the current road includes the current lane and the adjacent lane, the alert controller reduces the alert area on the side of the adjacent lane.

13. The vehicle control system as claimed in claim 1, wherein, when the position of the object detected by the detector is within the alert area on the left or right side of the vehicle, the alert controller causes the notifier to alert the occupant by a visual alert, and
wherein, when the position of the object detected by the detector is within the alert area on the left or right side of the vehicle and the vehicle intends to change lanes by a driver's operation toward the left or right side where the object is present, the alert controller causes the notifier to alert the occupant by a sound alert.

14. A vehicle control method for controlling an alert system for a vehicle, wherein the alert system comprises a detector configured to detect a position of an object near the vehicle, a notifier configured to alert an occupant in the vehicle, and an alert controller configured to control the notifier such that the notifier alerts the occupant based on a detection result provided from the detector, wherein the method comprises the alert controller performing operations to:
cause the notifier to alert the occupant when the position of the object detected by the detector is within alert areas set on left and right sides of the vehicle; and
when a current road on which the vehicle is traveling includes a current lane on which the vehicle is currently traveling, and an adjacent lane adjacent to the current lane or a branching lane branching off from the current lane, change the alert area on a side of the adjacent lane or the branching lane based on a shape of a target road on which the vehicle intends to travel.

15. A non-transitory computer-readable storage medium storing a vehicle control program which causes a computer to control an alert system for a vehicle, wherein the alert system comprises a detector configured to detect a position of an object near the vehicle, a notifier configured to alert an occupant in the vehicle, and an alert controller configured to control the notifier such that the notifier alerts the occupant based on a detection result provided from the detector, wherein the vehicle control program causes the alert controller to perform operations to:
cause the notifier to alert the occupant when the position of the object detected by the detector is within alert areas set on left and right sides of the vehicle; and
when a current road on which the vehicle is traveling includes a current lane on which the vehicle is currently traveling, and an adjacent lane adjacent to the current lane or a branching lane branching off from the current lane, change the alert area on a side of the adjacent lane or the branching lane based on a shape of a target road on which the vehicle intends to travel.
